(19) United States
(12) Patent Application Publication
(10) Pub. No.: US 2008/0013133 A1
(43) Pub. Date: Jan. 17, 2008

(54) CONTACT-TYPE COLOR SCANNING UNIT, IMAGE SCANNING DEVICE, IMAGE SCANNING METHOD, AND COMPUTER PROGRAM PRODUCT

(76) Inventor: Kazushige TAGUCHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/774,973

(22) Filed: Jul. 9, 2007

(30) Foreign Application Priority Data
Jul. 12, 2006 (JP) 2006-191841

(51) Int. Cl. H04N 1/46

(52) U.S. Cl. 358/514

(57) ABSTRACT

A contact-type color scanning unit includes an RGB line sensor including a plurality of sensors corresponding to each of red, green, and blue colors. Sensors of different color are arranged along a sub scanning direction and sensors of same colors are arranged in a main scanning direction. A first switching unit performs first switching including switching between image data of any two colors and passing the remaining one color as is without switching thereby obtaining switched image data corresponding to each of red, green, and blue colors. A correcting unit performs line-to-line correction on the switched image data corresponding to each of red, green, and blue colors thereby producing corrected image data corresponding to each of red, green, and blue colors. A second switching unit that performs second switching including switching again the image data of the two colors that were switched in the first switching thereby producing switched-back image data corresponding to each of red, green, and blue colors that is in same order as an order alignment of the sensors in the sub scanning direction.

### CROSS-REFERENCE TO RELATED APPLICATIONS

The present document incorporates by reference the entire contents of Japanese priority document, 2006-191841 filed in Japan on Jul. 12, 2006.

### BACKGROUND OF THE INVENTION

1. Field of the Invention

The present invention relates to a contact-type color scanning unit, an image scanning device, an image scanning method, and a computer program product.

2. Description of the Related Art

In recent years, the needs are increasing for performing duplex scanning, that is scanning both sides of a document, on scanning devices. In response to these needs, in the image scanning device disclosed in Japanese Patent Application Laid-Open No. H7-23178, scanners are arranged on both the sides of a transportation path of a document to be scanned, thereby allowing to perform duplex scanning of the document while the document is being transported via the transportation path. Because a reversing mechanism that reverses the document has not been employed, it is possible to downsize an image scanning device.

However, the technology disclosed in Japanese Patent Application Laid-Open No. H7-23178 can not be applied to color scanning, which involves complicated processing than monochrome scanning.

### SUMMARY OF THE INVENTION

It is an object of the present invention to at least partially solve the problems in the conventional technology.

According to an aspect of the present invention, a contact-type color scanning unit includes a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction; a first switching unit that performs first switching including switching between image data of any two colors and passing the remaining one color as is without switching thereby obtaining switched image data corresponding to each of red, green, and blue colors; a correcting unit that performs line-to-line correction on the switched image data corresponding to each of red, green, and blue colors thereby producing corrected image data corresponding to each of red, green, and blue colors; and a second switching unit that performs second switching including switching again the image data of the two colors that were switched in the first switching thereby producing switched-back image data corresponding to each of red, green, and blue colors that is in same order as an order alignment of the sensors in the sub scanning direction.

According to another aspect of the present invention, an image scanning unit includes an automatic document transporting device that automatically transports a document from a first position to a second position; and two contact-type color scanning units arranged between the first position and the second position, each of the contact-type color scanning units reading the document and outputting image data, each of the contact-type color scanning units including a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction; a first switching unit that performs first switching including switching between image data of any two colors and passing the remaining one color as is without switching thereby obtaining switched image data corresponding to each of red, green, and blue colors; a correcting unit that performs line-to-line correction on the switched image data corresponding to each of red, green, and blue colors thereby producing corrected image data corresponding to each of red, green, and blue colors; and a second switching unit that performs second switching including switching again the image data of the two colors that were switched in the first switching thereby producing switched-back image data corresponding to each of red, green, and blue colors that is in same order as an order alignment of the sensors in the sub scanning direction, wherein one of the contact-type color scanning units is a front-side scanning unit that scans a front side and other of the contact-type color scanning units is a back-side scanning unit that scans a back side of the document.

According to still another aspect of the present invention, a method of scanning an image to be implemented on a contact-type color scanning unit having a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction, includes first switching including switching between image data of any two colors and passing the remaining one color as is without switching thereby obtaining switched image data corresponding to each of red, green, and blue colors; performing line-to-line correction on the switched image data corresponding to each of red, green, and blue colors thereby producing corrected image data corresponding to each of red, green, and blue colors; and second switching including switching again the image data of the two colors that were switched in the first switching thereby producing switched-back image data corresponding to each of red, green, and blue colors that is in same order as an order alignment of the sensors in the sub scanning direction.

According to still another aspect of the present invention, a computer program product stores therein a computer program causes a computer to implement the above method of scanning an image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a color contact-image-sensor (CIS) scanning unit (contact-type color scanning unit) according to a first embodiment of the present invention;

FIG. 2 is a functional block diagram of an image corrector shown in FIG. 1;

FIG. 3 is a block diagram of an image scanning device that includes the CIS scanning unit shown in FIG. 1;

FIG. 4 is a functional block diagram of an image scanning device that includes an automatic document feeder (ADF);

FIG. 5 is a flowchart of a front-side CIS scanning operation according to the first embodiment;

FIG. 6 is a flowchart of a back-side CIS scanning operation according to the first embodiment;

FIG. 7 is a functional block diagram of a CIS scanning unit according to a third embodiment of the present invention;

FIG. 8 is a functional block diagram of an image corrector shown in FIG. 7;

FIG. 9 is a functional block diagram of a CIS scanning unit of a fourth embodiment;

FIG. 10 is a functional block diagram of an image corrector; and

FIG. 11 is a block diagram indicating the hardware structure of the image forming device of the embodiments.

### DETAILED DESCRIPTION OF THE PREFERRED EMBODIMENTS

Exemplary embodiments of the present invention are explained below while referring to the accompanying drawings.

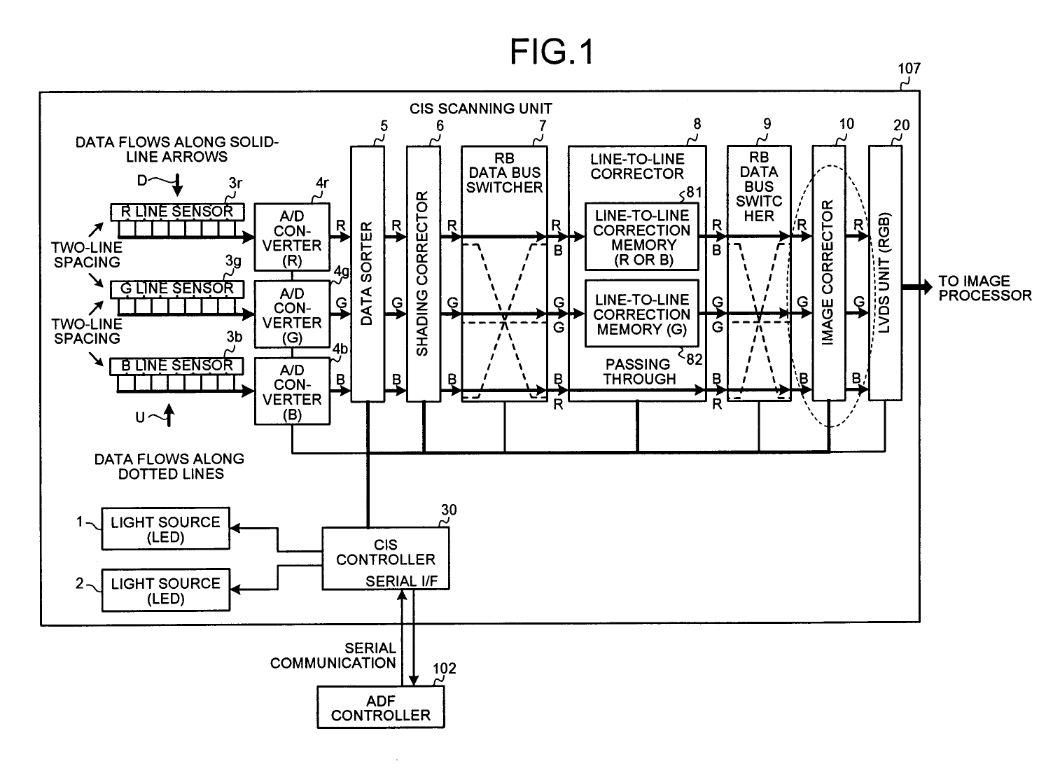

FIG. 1 is a functional block diagram of a color contact-image-sensor (CIS) scanning unit (contact-type color scanning unit) according to a first embodiment of the present invention. Such a CIS scanning unit is embedded in an image forming device, such as a multi function printer (MFP), or a scanner device.

The CIS scanning unit includes red-green-blue (RGB) line sensors 3r, 3g, 3b that read a document, an RB data bus switcher 7 that performs a first switching process, a line-to-line corrector 8 that outputs as a set of RGB data image data of the three RGB colors subjected to the first switching process by the RB data bus switcher 7, and an RB data bus switcher 9 that receives image data subjected to line-to-line correction by the line-to-line corrector 8 and switches again and outputs the image data of the two colors subjected to the first switching process. The RGB line sensors 3r, 3g, 3b are arranged with different colors in a sub scanning direction and the same colors in a main scanning direction. The first switching process includes switching any two colors of the image data read by the RGB line sensors 3r, 3g, 3b with each other and the remaining one color is passed as is without switching.

This structure enables the output of color image data of the same colors provided in a series and input at the time of color image scanning as a set of RGB data for the same pixel and enables scanning of an original document with a different transport direction by means of a single CIS scanning unit. The following is the explanation of the structure and operation of the CIS scanning unit of the first embodiment.

The color CIS scanning unit includes light sources 1 and 2. These light sources 1 and 2 illuminate the document. As a result, an unmagnified image on each of the RGB line sensor 3r, 3g, 3b in an SELFOC lens array (SLA, not shown). The RGB sensors are aligned in rows in the main scanning direction for each color, and the rows of each of these colors are aligned in the order RGB in the sub scanning direction. It is assumed for the sake of the explanation that the lines of each color are arranged at two-line spacing.

Each RGB line sensor is separated into a plurality of channels (e.g., eight) for each of a plurality of chips (e.g., three). Moreover, 8-channel A/D converters (for red, green, and blue) 4r, 4g, 4b process the signals output from chips thereby obtaining parallel image data, and output the parallel image data to a data sorter 5. The data sorter 5 converts the parallel image data for each color to serial image data of one line of each RGB color. The serial image data sorted is converted to a set of RGB data at the position of one pixel through the process below.

The image data subjected to serial processing into one line by the data sorter 5 is input to a shading corrector 6 where any light quantity fluctuation of illumination and image output fluctuation are corrected. The shading corrected image data is output to the line-to-line corrector 8. The RB data bus switcher 7 is provided at the previous stage and the RB data bus switcher 9 is provided at the subsequent stage of the line-to-line corrector 8.

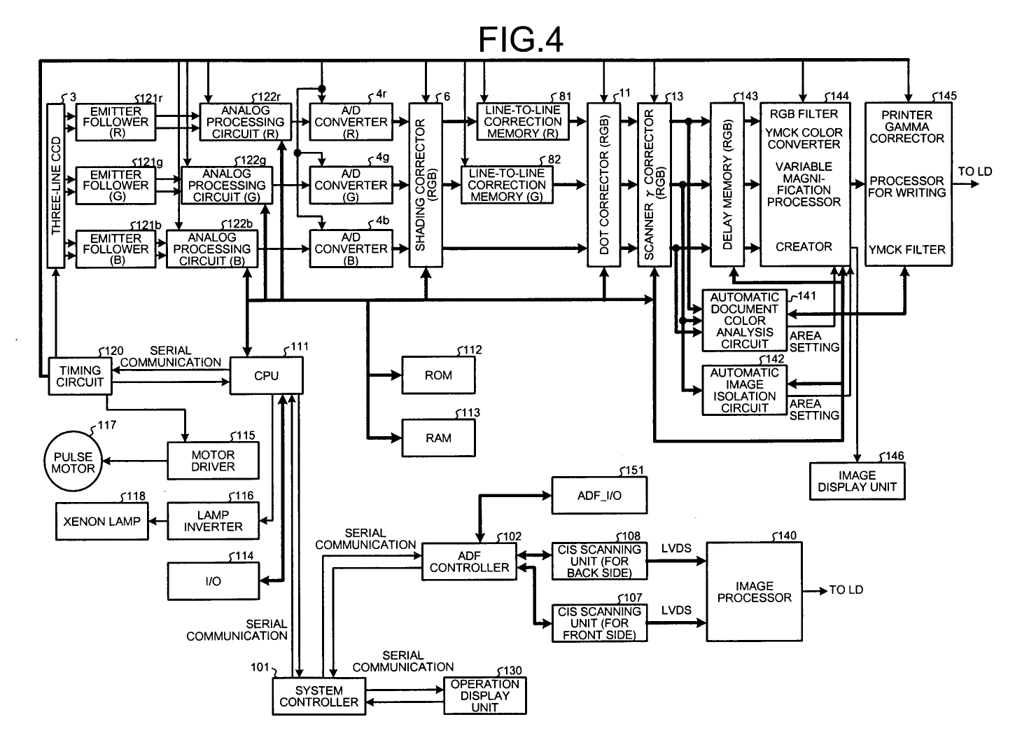

The operation of the RB data bus switchers 7 and 9 is explained in greater detail later. In the meanwhile, the output from the RB data bus switcher 9 is input to the image corrector 10 where it is subjected to image processing, and is then sent to a low voltage differential signaling (LVDS) unit 20 where it is converted to a low voltage differential signaling (LVDS) signal, and finally sent to an image processor (not shown) on the body of an image forming device. A CIS controller 30 provides overall control on the CIS scanning unit, such as light source control, correction control, and control for serial communication with an ADF controller 102 (see FIG. 4).

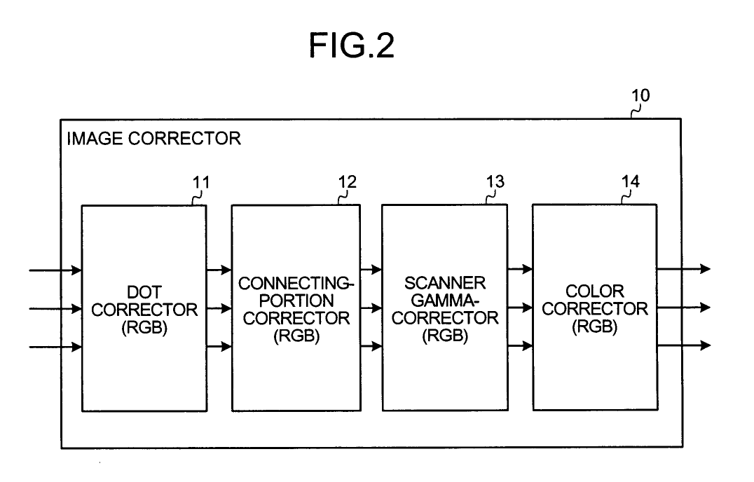

FIG. 2 is a functional block diagram of the image corrector 10. The image corrector 10 is includes a dot corrector 11, a connecting-portion corrector 12, a scanner gamma-corrector 13, and a color corrector 14. Each of these units performs processes within the CIS scanning unit, thereby performing image correction specific to the CIS scanning unit, enabling improved image quality.

The dot corrector 11 corrects dot misalignment within one line, which cannot be corrected using line-to-line correction. Due to the structural characteristics of the CIS scanning unit, a gap of one pixel is any way produced between two adjacent chips of a plurality of sensor chips. The connecting-portion corrector 12 corrects this gap of one pixel by using the image data of the chips at both sides of the gap. The scanner gamma-corrector 13 corrects the reflectivity linear data for each chip or for each pixel by referring to a lookup table. The color corrector 14 performs corrections for each chip or pixel by referring to a three-dimensional lookup table.

This section explains the RB data bus switching for line-to-line correction. The CIS controller 30 performs the switching control of the RB data bus switchers 7 and 9. The RB data bus switcher 7 sends image data via a data flow path indicated with solid-line arrows in FIG. 1 when the image data is read in the order of red, green, and blue indicated by downward pointing arrow D, which represents the document transport direction, for locations where each RGB line sensor 3r, 3g, 3b is lined up in the diagram. In this case, all image data of the three colors are passed through, i.e., no switching is performed. This is the case when the RGB line sensors 3r, 3g, 3b scan a document in the order of red, green, and blue, which is the alignment sequence of the line sensors.

The line-to-line corrector 8 includes line-to-line correction memories 81 and 82. Because the spacing between lines is two lines, the line-to-line correction memory 81 delays R data by four lines, and the line-to-line correction memory 82 delays G data by two lines. B data is not delayed. This operation enables scanning along the same RGB line. In this case, the RB data bus switcher 9 sends image data via the data flow path indicated by solid-line arrows. Namely, the RB data bus switcher 9 allows the image data to pass through, i.e., none of the three colors is switched.

In this manner, although RGB data are acquired at different timings by the RGB sensors, because of the delay operation, the image data of each of the RGB colors appear to be located at one pixel.

Subsequently, the RB data bus switcher 7 switches data flow paths to the path indicated by dotted lines in FIG. 1 and transposes image data when the image data is read in the order of blue, green, and red indicated by an upward pointing arrow U, which represents the document transport direction, for the positions where the RGB line sensors 3r, 3g, 3b are lined up in the diagram. In this case, a selector circuit (not shown) switches the image data buses whereby R data output from the RB data bus switcher 7 is input to B of the line-to-line corrector 8 and B data output from the RB data bus switcher 7 is input to R of the line-to-line corrector 8.

In this condition, because the spacing between lines is two lines, in the line-to-line corrector 8, four lines are delayed in the line-to-line correction memory 81 for B data and two lines are delayed in the line-to-line correction memory 82 for G data being passed through, and R data has no delay. RGB is scanned along the same line as a result of such line-to-line correction. In this case, the RB data bus switcher 9 switches by means of a selector circuit (not shown) in the direction indicated by a dotted line. This switching enables scanning along the same RGB line.

The image data of the same colors provided in a series is converted to a set of RGB data at the position of one pixel, and appropriate RGB input to the image corrector 10 of the subsequent stage is possible.

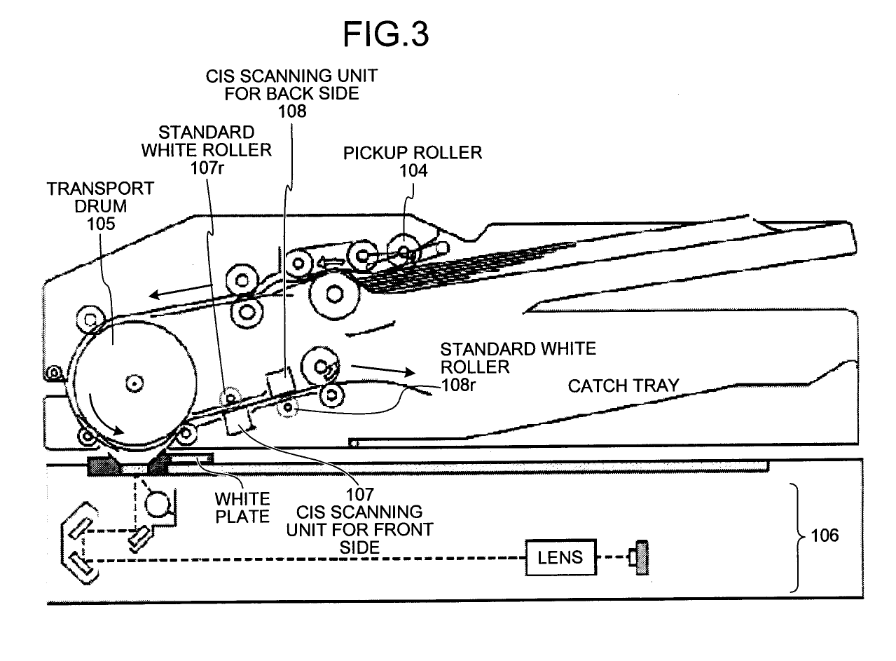

FIG. 3 is a block diagram of the image scanning device provided with the CIS scanning unit of the first embodiment. The operation of the image scanning unit itself is generally publicly known art and, therefore, will be explained later. This section mainly explains the components related to the first embodiment.

A two-sided document is fed from a pickup roller 104 on the image scanning device and it is transported with a transport drum 105, and passes over a scanning position corresponding to a reduction optical system 106. A CIS scanning unit 107 for front-side is positioned downstream of the scanning position, and a CIS scanning unit 108 for back-side is positioned downstream of the CIS scanning unit 107. Stable document transport without pushing up of the document, and scanning operations are made possible by providing standard white rollers 107r and 108r that oppose each of the CIS scanning units 107 and 108. Differences in the image quality due to differences in the scanning method can be prevented by providing separate CIS scanning units 107 and 108 for each of the front and back sides.

Providing this type of CIS arrangement enables a structure for compact, one-pass, double-sided scanning and improves productivity. In addition, to enable the front-side CIS scanning unit 107 and the back-side CIS scanning unit 108 to eliminate differences in image quality, it is desirable to have CIS scanning units with the same performance. This is because differences in image quality for the front and back can be decreased by making equal the resolution and gradation and by making equal as much as possible the spectral distribution of the sensors and the spectral distribution of the light sources (LED spectral distribution).

Color CIS scanning units that scans color documents and reduction type color CCDs have color-related problems, and conventional black-and-white CISs and reduction type black-and-white CCDs have problems that exceed differences in image quality, therefore this type of structure provides a great benefit for color scanning.

FIG. 4 is a functional block diagram of the image scanning unit that has an automatic document feeder (ADF). The general structure and operation of the image scanning device is publicly known and, therefore, will be explained later. This section mainly explains the components related to the first embodiment. The CIS scanning unit 107 (for the front side) is a contact type image sensor that scans the front side of a document, and this structure is as explained in FIG. 1.

This CIS scanning unit 107 inputs commands and drive clock from the ADF controller 102 and reads the image data. The image data output from each CIS scanning unit 107 and 108 is input to an image processor 140 in the subsequent stage as an LVDS signal by means of the LVDS unit 20.

At this image processor 140, the image data from each CIS scanning unit 107 and 108 is, unlike conventional examples, subjected to the same process as that of the image processing functions (11, 13, 143-145) shown in FIG. 4 and output to the LD. However, when two-sided image forming is not performed on the side of the image forming device, control is performed so as to form an image on each side. Here, it is possible to further improve the image quality by means of separating the function of the image processor 140 on the body side shown in FIG. 4 and the image processing function provided on the CIS scanning unit side.

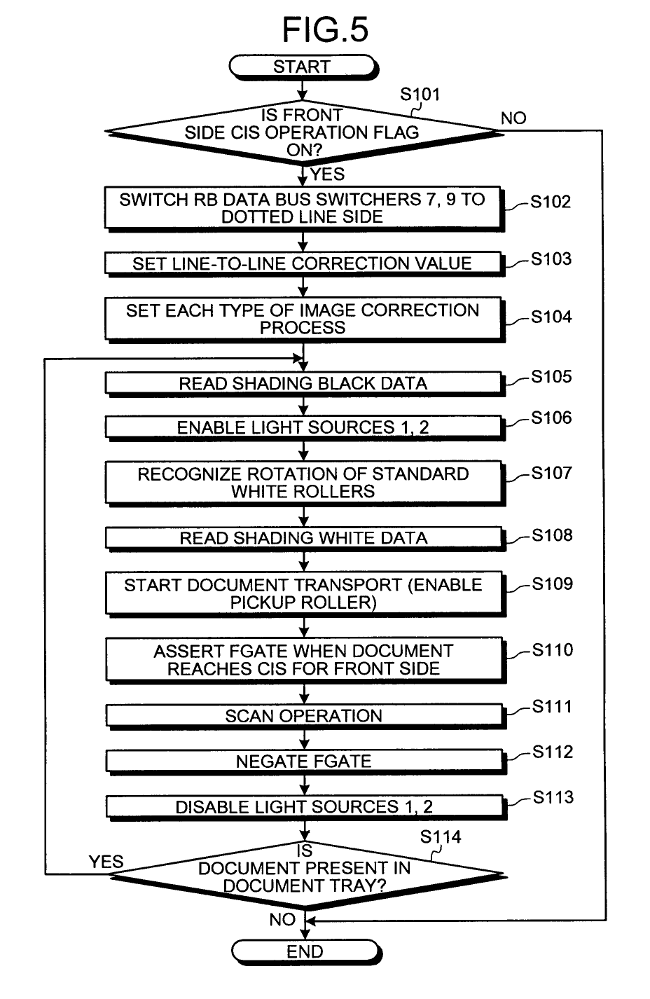

FIG. 5 is a flowchart that explains the procedure of the front side CIS scanning operation of the first embodiment. The scanning operations of the front side CIS scanning unit 107 and the back side CIS scanning unit 108 are explained. First, the front side CIS scanning operation is explained.

In the functional block diagram of the image scanning device shown in FIG. 4, the ADF controller 102 controls the operations of the scanning unit 107 for the front side and the CIS scanning unit 108 for the back side. The ADF controller 102 controls each CIS scanning unit 107 and 108 by means of serial communication operation commands from a system controller 101. When the user sets a two-sided document on a document tray shown in FIG. 3, selects and presses a simultaneous two-sided color scanning mode key (not shown) from an operation display unit 130 shown in FIG. 4, and presses a start key, each setting from the operation display unit 130 is sent to the system controller 101 by serial communication commands.

When the simultaneous two-sided color scanning operation command is sent from the system controller 101, the ADF controller 102 enables the front side CIS operation flag and the back side CIS operation flag and performs the scanning procedure. The ADF controller 102 checks the front side CIS operation flag (step S101), and if disabled (“No” in step S101), a return occurs without performing the process. If enabled (“Yes” in step S101), the CIS controller 30 (FIG. 1) controls switching of the selector circuit of the RB data bus switchers 7 and 9 on the color CIS scanning unit in FIG. 1 to the dotted line side (step S102).

The CIS controller 30 sets the line-to-line correction (step S103) by a variable magnification instruction according to the serial command from the ADF controller 102 and sets each type of image correction process (step S104).

Next, shading black data reading is performed for shading (step S105). The light sources 1, 2 are enabled (step S106), rotation of the standard white rollers is recognized (step S107), and shading white data reading is performed (step S108). Document transport is started (the pickup roller is enabled) and the document is transported (step S109).

When the document reaches the scanning surface of the CIS scanning unit 107 for the front side, the FGATE is asserted (step S110) and scanning begins (step S111). When the document surface passes beyond the back end of the scanning surface of the CIS scanning unit 107 for the front side, the FGATE is negated (step S112) and the light sources 1, 2 are disabled (step S113).

It is determined whether there is a document in the document tray (step S114), and when it is determined that a document is present (“Yes” in step S114), operations return to the shading black tape reading (step S105) and the same process is performed. This is repeatedly performed until the document is no longer present. When it is determined that the document is no longer present (“No” in step S114), a return is performed and the front side CIS operation process is terminated. In this example, the CIS scanning unit for the front side has a structure that performs image data switching. However, whether to perform image data switching for either the front side or back side can be arbitrarily set.

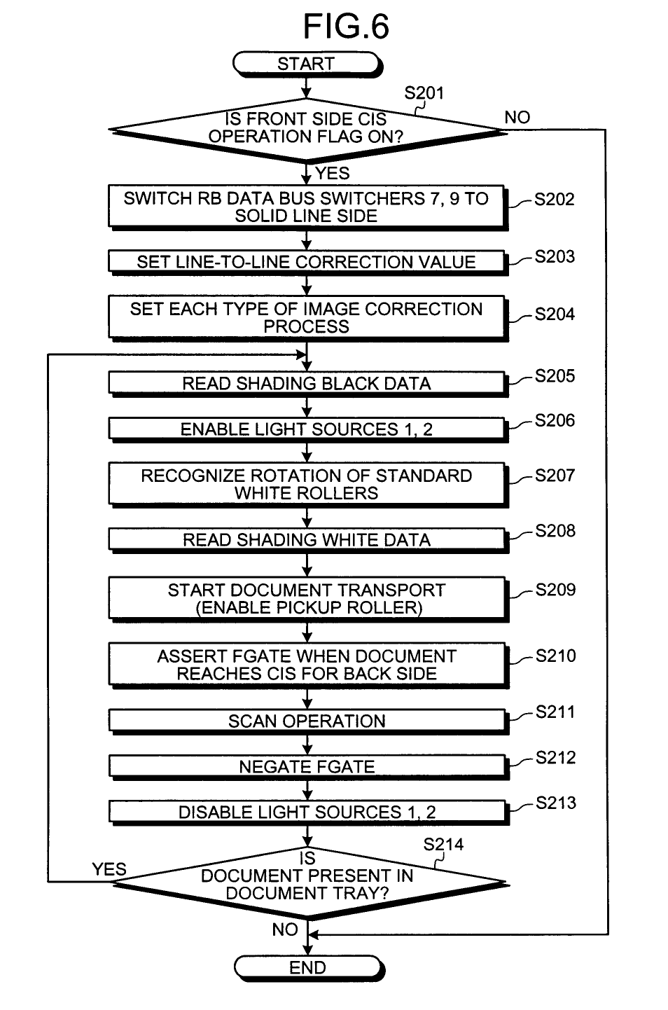

FIG. 6 is a flowchart that explains the procedure of the back side CIS scanning operation of the first embodiment. The points of the back side CIS scanning operations that differ from the front side CIS scanning operations are mainly explained. The control operation that switches the selector circuit of the RB data bus switcher 7, 9 to the solid line side (step S202) for the back side CIS scanning operation differs from the front side CIS scanning operation. Namely, the back side CIS scanning operation here allows RGB image data to pass without being switched during document transport indicated in FIG. 3.

In addition, the back side CIS scanning operation differs from the front side CIS scanning operation when the document reaches the scanning surface of the CIS for the back side in FIG. 3 and then the FGATE is asserted (step S210) and scanning begins (step S211) and when the document surface passes beyond the back end of the scanning surface of the CIS for the back side and then the FGATE is negated (step S212).

This section explains performing two-sided simultaneous scanning using two of the same color CIS scanning units indicated in FIG. 3 as an example of transposing RB before and after line-to-line correction. With this type of structure, because the scanning surfaces of the CIS scanning unit 107 for the front side and the CIS scanning unit 108 for the back side face each other, when the document transport direction is in the direction indicated by an arrow in FIG. 3, the document scanning direction indicated in FIG. 1 for the CIS scanning unit 108 for the back side is arrow D. In comparison, the document transport direction for the CIS scanning unit 107 for the front side is arrow U. The order in which the RGB colors of the three line sensors for these two CIS scanning units are lined up in the sub scanning direction is the reverse order for one another in the transport direction of a single document.

From the positional relation of these two CIS scanning units, handling of the differences in transport direction is possible by switching image data by means of providing the RB data bus switchers 7 and 9 inside a color CIS scanning unit as in the present invention.

An image data harness, a serial communication harness, other control data line harnesses, and a power supply harness are extracted from the color CIS scanning unit, and the harness to open and close the ADF can be extracted from the back side, namely the ADF hinge side, thereby making the overall harness wire length shorter and orienting the harness to occupy as little space as possible.

As such, the arrangement of each harness connector in the hinge direction side is preferable on the color CIS scanning unit. Because a structure is provided that enables harness extraction from the hinge side on both the front side CIS scanning unit 107 and the back side CIS scanning unit 108 for this reason, this problem can be solved by providing the transpose function in the color CIS scanning unit.

In addition, providing the same overall shape, connector shape, and connector position of the front side CIS scanning unit and the back side CIS scanning unit provides the benefit of orienting the harnesses that enables the same direction and length.

In this way, when installing the color CIS scanning unit, the design of the CIS scanning units for the document transport direction can be flexibly achieved by providing the line-to-line corrector 8 that has the line-to-line correction memories 81 and 82.

Without this type of transpose function, an arrangement by changing the orientation with a 180° inversion in the longitudinal direction is required to align the RGB lines and document transport direction, and to reverse the orientation at which the harness is extracted when loading into an ADF with very little space, the spatial arrangement becomes extremely inefficient. In addition, it is possible to solve problems wherein the machine becomes taller by widening the ADF space and ADF user operability decreases.

In a certain conventional example, although one-pass two-side simultaneous scanning can be performed, the front side is scanned using a CCD of the reduction optical system 106 indicated in FIG. 3 and the back side is scanned using a CIS, thus differences in the scanning image quality occurred. As differences in image quality, differences in the color due to light source spectral distribution and sensor spectral distribution occurred, a level of deterioration in the MTF due to focal depth presence occurred, and image deterioration at the connecting point (occurrence of images with lines) and uneven sensitivity between chips occurred due to the sensor chips being connected and aligned on the CIS. A reduction type CCD has one chip, thus no fluctuation in sensitivity between chips occurs. The differences in this scanning method appeared as differences in image quality, but the differences in image quality due to this type of scanning method can be eliminated by means of providing the CIS scanning unit of the first embodiment on both the front side and back side.

While the line-to-line correction value when performing regular magnification scanning for the CIS scanning unit of the first embodiment has been explained, line setting according to the transport speed is performed during variable magnification scanning. For example, at 200% enlargement, the transport speed becomes half that at normal magnification, and eight lines are delayed in the line-to-line correction memory 81 for R data and four lines are delayed in the line-to-line correction memory 82 for G data, thus enabling image data along the same RGB line.

When the enlargement variable magnification ratio increases in this way, the line-to-line memory increases according to the ratio. At 50% reduction, the transport speed becomes double that at normal magnification, and two lines are delayed in the line-to-line correction memory 81 for R data and one line is delayed in the line-to-line correction memory 82 for G data, thus enabling image data along the same RGB line.

Here, at zoom variable magnification, a line difference equal to or less than one line occurs. In this case, the dot corrector 11 corrects less than one line. In the correction of less than one line, the correction value is calculated by interpolating using the lines before and after the target line. For example, calculations are performed supplemented by the cubic function convolution method, thus enabling the output of image data along the same RGB line.

The CIS scanning unit of a second embodiment uses a CIS scanning unit of the first embodiment on a flatbed scanner. When there are two flatbed scanners A and B (not shown) that have different document scanning directions, scanning can be performed in either scanning direction within the CIS scanning unit by means of an RB image bus switcher, thus providing the benefits of shared installation parts of the CIS scanning unit, shared harness orientation, and shared image processing functions.

For the CIS scanning unit according to the present embodiment of the present invention that has an RB image bus switching function, it is preferable that the illumination device have two-light illumination from both sides enclosing the RGB line sensor. Although it is difficult for problems to occur with a normal document with one-light illumination on one side, when scanning a document with a slight uneven surface, such as that of a cut-and-pasted document, because the transport direction differs for the back side CIS scanning unit and the front side CIS scanning unit, the direction of shadows created by the illumination differs even when reading the same cut-and-pasted document, and a problem occurs in which the scanned document is different. The difference in the front and back images can be effectively eliminated by means of combining the RB switching function and two lights on both sides.

In addition, it is preferable that the light source be a light emitting diode (LED) for the structure, wherein illumination shines from both sides within the CIS scanning unit. This is because this enables lower power consumption and lower generated heat from the light source.

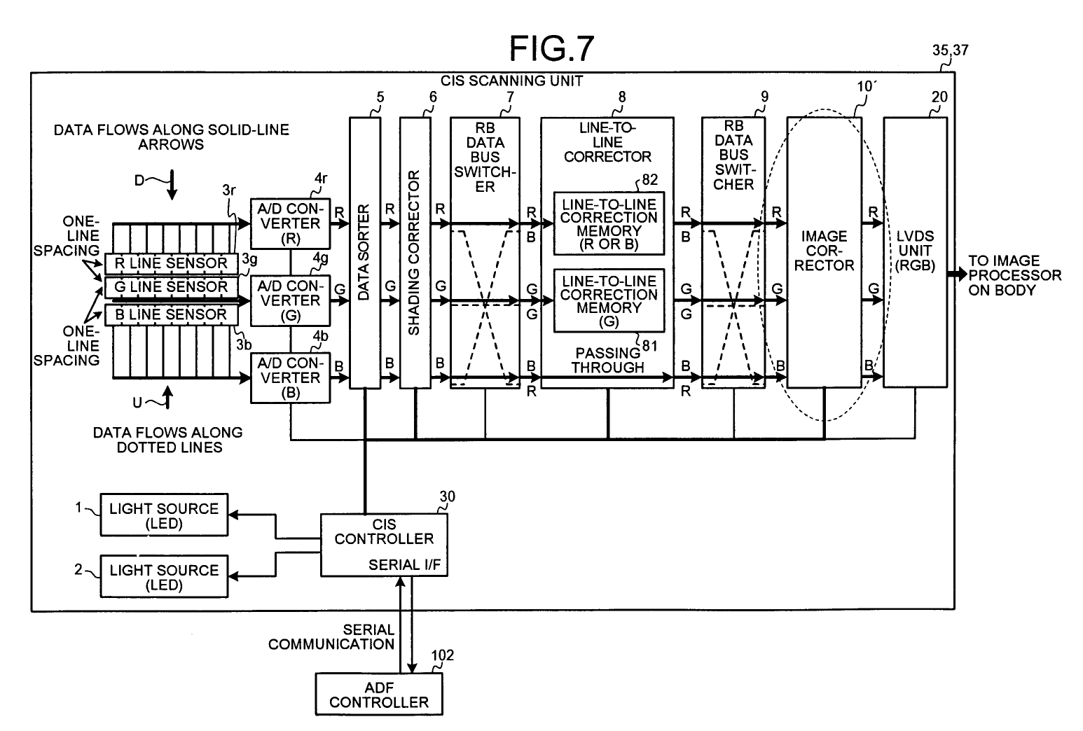

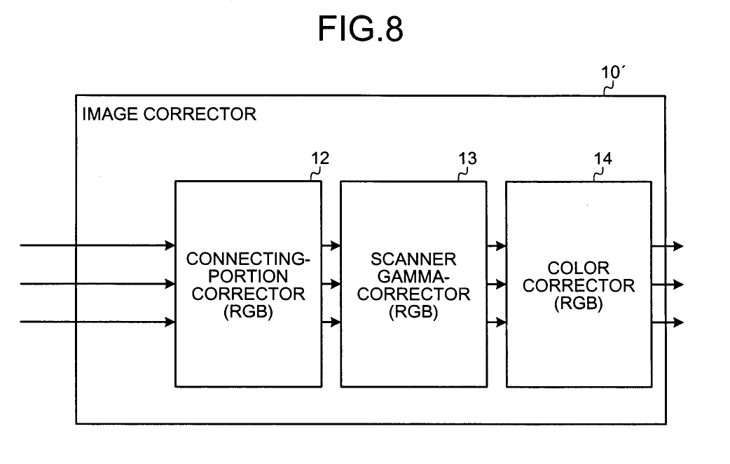

FIG. 7 is a functional block diagram of the CIS scanning unit of a third embodiment. FIG. 8 is a functional block diagram of the image processor. Here, the line spacing is one line and the structure does not include dot correction in the image correction process.

The RGB line sensors 3r, 3g, 3b use CMOS sensors. A structure can be provided for the CCD as well; however, because there is no shift register for the CMOS sensors, the method enables smaller line spacing and easier provision of a one-line space structure.

Because the line spacing is one line, the line-to-line correction memory 81 of the line-to-line corrector 8 has a structure with a two-line memory and the line-to-line correction memory 82 has a structure with a one-line memory. The operations of the RB data bus switchers 7 and 9 that transpose RB are as explained in the first embodiment.

An image corrector 10′ has a structure in which the dot corrector 11 (FIG. 2) in the image corrector 10 is omitted. This is an example of the document transport speed only at normal magnification speed, and the cost can be reduced by means of eliminating dot correction with the line-to-line correction memory at the minimum required amount as described. Scanning operations are only at normal magnification, but variable magnification as an image forming device can be provided as electrical variable magnification for a block 144 that includes a variable magnification processing function within the image processor 140 on the body side indicated in FIG. 4.

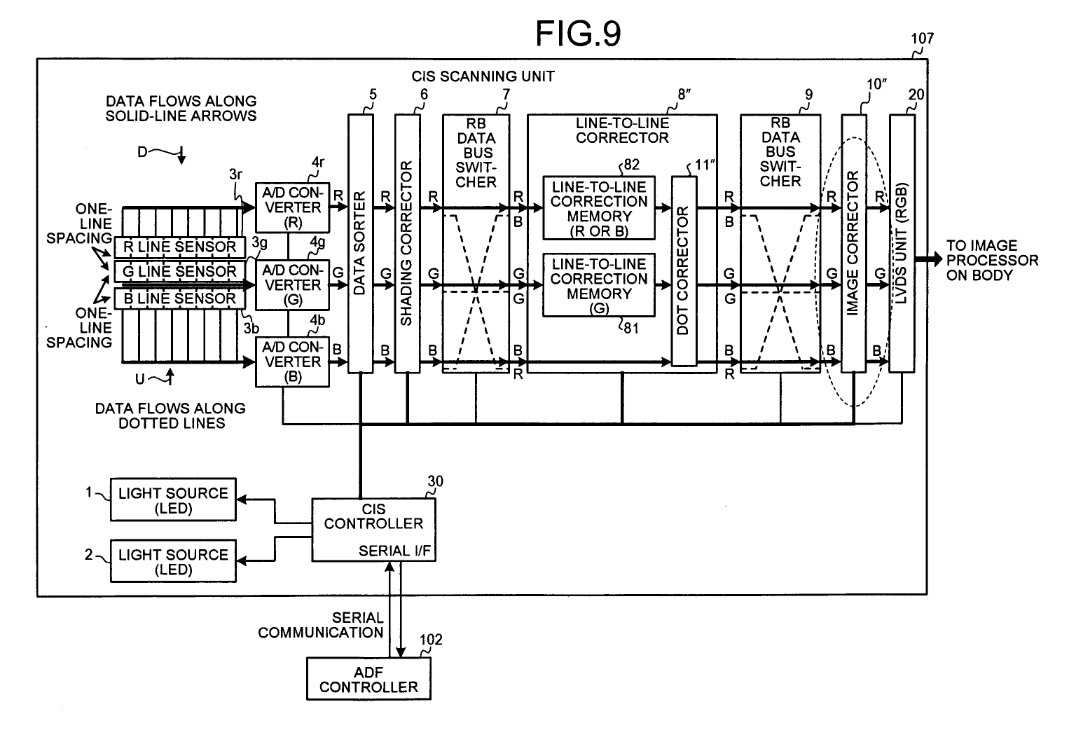

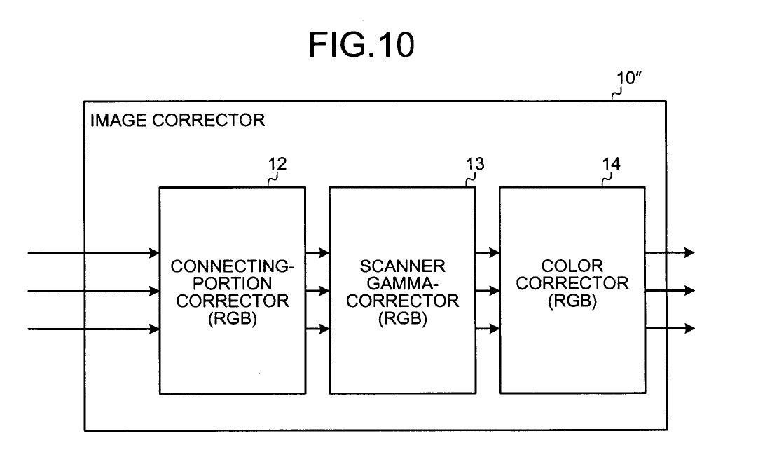

FIG. 9 is a functional block diagram of the CIS scanning unit of a fourth embodiment. FIG. 10 is a functional block diagram of an image corrector. The point of difference with the first embodiment is that the fourth embodiment is provided with a dot corrector 11″ within the line-to-line corrector 8″. Furthermore, there is no dot corrector within the image corrector 10″.

When the document transport speed exceeds the normal magnification speed, namely during reduction operation, correction within one line is required. In this case, memory sharing is possible by means of performing dot correction at the same time for the line-to-line corrector 8″.

In this way, the reduction operation, namely the document transport speed, can be increased, thus enabling an increase in the scanning operation efficiency. With the structure of the fourth embodiment, the efficiency can be improved without increasing the cost.

The benefit of having the line-to-line corrector inside the CIS scanning unit is that color fluctuation between chips is corrected for each chip or for each pixel, thus enabling color correction to be performed within the CIS scanning unit. This correction process enables correction of the spectral distribution fluctuation of the sensor filter that cannot be removed with shading correction, thus enabling the prevention of image deterioration due to lines and unevenness. For this reason, correction is possible even when there is fluctuation in each chip due to a transition of the lot of the sensor filter, enabling higher image quality. RGB data for the same line is required for color correction, thereby making the most of the benefit of enabling line-to-line correction by performing color correction within the CIS scanning unit.

The CIS scanning unit of one variation has a structure (not shown) with a changed alignment sequence of the three line sensors. For example, the alignment sequence of the three line sensors is in the order of RGB along the document transport direction for the positions indicated in FIG. 1, but a structure in the order GRB is also possible. The bus switching corresponding to the structure with this sequence is that with the GB data transposed.

As the CIS scanning unit of another variation, the alignment sequence of the three line sensors that is in the order of RGB for the positions indicated in FIG. 1 can be configured in the order GBR (not shown). The bus switching corresponding to the structure with this sequence is that with the GR data transposed.

This section explains the general structure and image scanning operation of the image scanning device indicated in FIG. 4. A central processing unit (CPU) 111 on a scanner IPU controller runs a program stored in a read only memory (ROM) 112 and reads and writes data and the like from and to a random access memory (RAM) 113, thereby fully controlling the scanner and IPU. The system controller 101 communicates by serial communication and performs the operations instructed by sending and receiving commands and data. The system controller 101 is also connected to the operation display unit 130 via serial communication and sets the operation mode and other instructions by key input instructions from the user.

In addition, the CPU 111 is connected to an input/output (I/O) 114, such as a document detection sensor, HP sensor, pressure plate switching sensor, and cooling fan, and controls detection and On/Off operation. A motor driver 115 is driven by PWM output from a timing circuit 120 to generate an excitation pulse sequence, and drives a pulse motor 117 that drives document scanning.

The light signal from the document image passes through a plurality of mirrors and a lens and forms an image on a three-line CCD 3 by means of the light amount output from a xenon lamp 118 driven by a lamp inverter 116. The three-line CCD 3 is provided with each drive clock by means of the timing circuit 120 on the scanner IPU control, and the odd and even analog image signals for each RGB are output to an emitter follower 121r, 121g, 121b. The setting from the CPU 111 can be used to select whether a normal sample/hold is performed inside an analog processing circuit 122r, 122g, 122b, or whether a sample/hold is performed after executing CDS for the signal input from the emitter follower 121r, 121g, 121b to the analog processing circuit 122r, 122g, 122b.

Line clamping is performed at the optical black unit of the CCD as a process of the analog processing circuit 122r, 122g, 122b, the difference in odd and even output is corrected, and the amp gain for each is adjusted. After the gain is adjusted, synthesis is performed using a multiplexer, and after the final offset adjustment of the DC level, input to the A/D converter 4r, 4g, 4b is performed.

The analog signal input to the A/D converter 4r, 4g, 4b is digitized and input to the shading corrector 6. The shading corrector 6 has a function to correct the light amount unevenness of the illumination system and the fluctuation of CCD pixel output. Shading-corrected image data is input to the line-to-line correction memories 81 and 82, the image data of the number of lines of pairs B and G and pairs B and R of the three-line CCD are delayed in the memories, a position alignment of equal to or more than one line of the BGR scanning image is performed, and output to the dot corrector 11 is performed.

The dot corrector 11 corrects dot deviations of equal to or less than one line of the RGB data for image data output from the line-to-line correction memories. The scanner gamma-corrector 13 corrects the reflectivity linear data using the lookup table method. The corrected image data is subjected to each process performing each function, namely an RGB filter, YMCK color converter, variable magnification processor, and creator, for the block 144 via an automatic document color analysis circuit 141, an automatic image isolation circuit 142, and a delay memory 143.

The automatic document color analysis circuit 141 performs the automatic color sensing (ACS) process, and input to the automatic image isolation circuit (text/halftone dot) 142 is performed. During the ACS process, determination of black and gray is performed. During the segmentation process, edge determination (determined by the continuation of white pixels and black pixels), halftone dot determination (determined by repeating patterns of hills and valleys peak pixels in the image), and picture determination (when image data that is not text or halftone dot is present) are performed, the areas of text and print (halftone dot) and pictures are determined and transmitted to the CPU 111, and are used for parameter and coefficient switching by the RGB filter, color conversion printer gamma correction, YMCK filter, and gradation process for the block 144 in the subsequent stage.

The image data is input to the RGB filter of the block 144. At the RGB filter, the RGB MTF correction, smoothing, edge enhancement, through and other filter coefficients are switched and set using the determination areas. At the YMCK color converter, YMCK conversion from RGB data, UCR, and UCA processing are performed. The main scanning image data input to the variable magnification processor is enlarged or reduced. Branching to an image display unit 146 is performed after this process. The block 144 is connected to the image display unit 146 via an interface.

At the function processing unit of the creator, create editing and color processing are performed. During create editing, italicization, mirroring, shadowing, outlining, and the like are performed. During color processing, color conversion, specified color erasing, under color processing, and the like are performed.

At the printer gamma corrector and YMCK filter of a block 145, the printer gamma conversion and filter coefficient are set based on the determination areas. During gradation processing, dither processing is performed. During video control, write timing setting, image area and outline area setting, and grayscale, color pitch and other test patterns can be generated. At the processor that writes the final image data, a process is performed to enable output to a laser diode (LD) and output to the LD is performed.

Each function process is connected to the CPU 111, and by means of a program stored on the ROM 112, the setting and operation of each function are executed by instructions from the system controller 101.

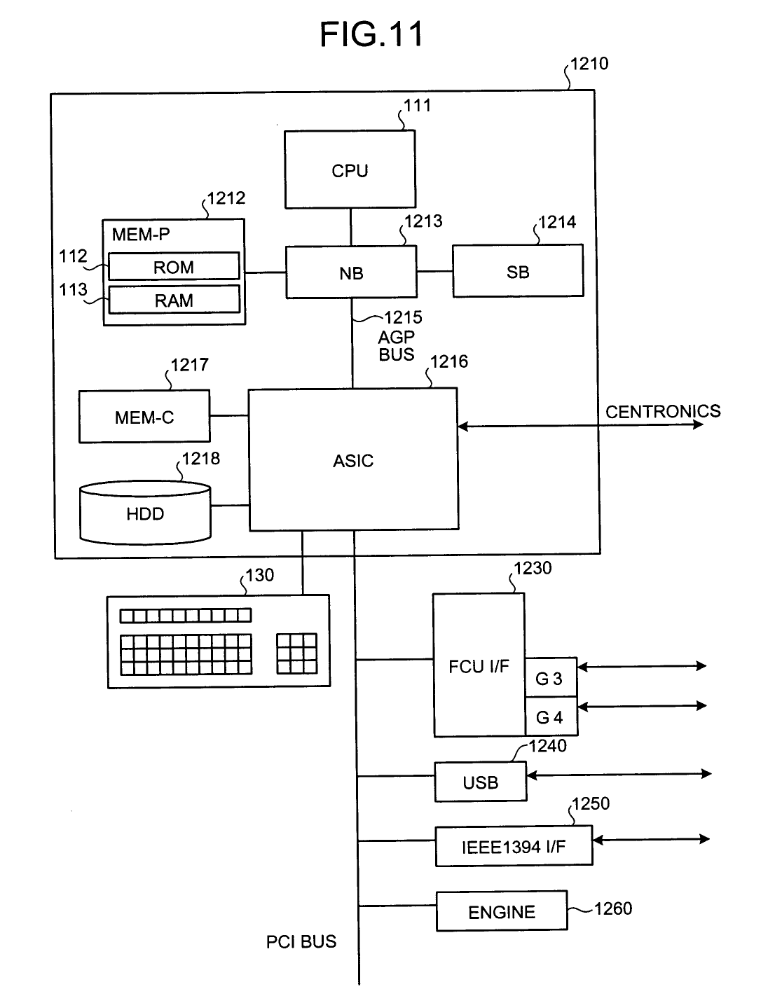

FIG. 11 is a block diagram indicating the hardware structure of the image forming device of the embodiments. The image scanning device that has the CIS scanning unit can be applied as an image scanning device that performs a scanning function for an image forming device.

This image forming device is comprised as a multifunction product (MFP) provided with multiple functions, such as a fax machine and scanner. As shown in the diagram, this MFP is comprised of a controller 1210 and an engine 1260 connected by a peripheral component interconnect (PCI) bus. The controller 1210 is a controller that provides overall MFP control, document scanning control, image processing control, rotation drive control, and various control controls on input from an FCU interface 1230 and the operation display unit 130. The engine 1260 is an image processing engine or the like that can be connected to a PCI bus, and, for example, includes an image processor that performs error diffusion and gamma conversion for obtained image data.

The controller 1210 has the CPU 111, a north bridge (NB) 1213, a system memory (MEM-P) 1212, a south bridge (SB) 1214, a local memory (MEM-C) 1217, an application specific integrated circuit (ASIC) 1216, and a hard disk drive (HDD) 1218, and has a structure, wherein the NB 1213 and the ASIC 1216 are connected by an accelerated graphics port (AGP) bus 1215. In addition, the MEM-P 1212 has the ROM 112 and the RAM 113.

The CPU 111 controls the entire MFP, has a chipset comprising the NB 1213, the MEM-P 1212, and the SB 1214, and is connected to another device via this chipset.

The NB 1213 is a bridge that connects the CPU 111 to the MEM-P 1212, the SB 1214, and the AGP bus 1215, and has a memory controller that controls reading and writing from and to the MEM-P 1212 and a PCI master and AGP target.

The MEM-P 1212 is a system memory that is used as a memory that stores programs and data and that develops programs and data, and comprises the ROM 112 and the RAM 113. The ROM 112 is a read-only memory used as a memory that stores programs and data, and the RAM 113 is a memory that enables writing and reading and is used as a memory that develops programs and data and an image drawing memory during image processing.

The SB 1214 is a bridge that connects the NB 1213 to a PCI device and peripheral devices. This SB 1214 is connected to the NB 1213 via the PCI bus, and this PCT bus is connected to the FCU interface 1230 and the like.

The ASIC 1216 is an integrated circuit (IC) for multimedia information processing applications that has a hardware element for multimedia information processing, and serves as a bridge that connects the AGP bus 1215, the PCI bus, the HDD 1218, and the MEM-C 1217.

This ASIC 1216 enables connections among the PCI target and AGP master, an arbiter (ARB) at the core of the ASIC 1216, the memory controller that controls the MEM-C 1217, a plurality of direct memory access controllers (DMACs) that rotate image data and the like using hardware logic, and the engine 1260 by a universal serial bus (USB) 1240 and an IEEE (the Institute of Electrical and Electronics Engineers) 1394 interface 1250 via the PCI bus.

The MEM-C 1217 is a local memory used as a buffer for images to be sent and as a code buffer. The HDD 1218 is storage that accumulates image data, programs, font data, and forms.

The AGP bus 1215 is a bus interface for a proposed graphics accelerator card that increases the graphics processing speed, and increases the speed of the graphics accelerator card by directly accessing the MEM-P 1212 at high throughput.

The operation display unit 130 that is connected to the ASIC 1216 receives operation input from the operator and sends the received operation input information to the ASIC 1216.

The image scanning program executed by the image forming device of the embodiments can be recorded for provision to computer-readable recording media, such as a CD-ROM, flexible disk (FD), CD-R, or digital versatile disk (DVD) in a file with an installable or executable format.

In addition, the image scanning program executed by the MFP of the embodiments can be stored to a computer connected to a network, such as the Internet, and downloaded for provision over a network.

The image scanning program executed by the MFP of the embodiments has a modular structure that includes the various components associated with image scanning. In terms of the actual hardware, the CPU (processor) reads and executes the image scanning program from the ROM, thus each image scanning function is generated on the main recording device.

An aspect of the present invention achieves an effect of enabling the output of RGB serial data as RGB image data for the same pixel regardless of the difference of the transport direction of the document by means of a first switching process wherein any two colors of the image data read by the RGB line sensor are switched with each other and the remaining one color is passed as is without switching, a line-to-line correction process wherein the image data of the three RGB colors subjected to the first switching process are output as an RGB image data set, and a second switching process wherein the image data subjected to the line-to-line correction process is received, the image data of the two colors subjected to the first switching process is switched again and output as the RGB data of a set based on the order of the sub scanning direction scanned by the RGB line sensor.

Another aspect of the present invention achieves an effect of enabling the output of RGB serial data as RGB image data for the same pixel, regardless of the difference of the transport direction of the document, by means of the line-to-line correction outputting two pieces of the received image data subjected to the first switching process after holding for different time periods, as a set of RGB data.

Still another aspect of the present invention achieves an effect of enabling the document image of both the front side and back side to be correctly scanned without being affected by irregularities of the document by means of enclosing the line sensor and illuminating from a plurality of directions the document image to be scanned.

Still another aspect of the present invention achieves an effect of enabling higher quality scanning by means of performing image correction for image data subjected to the second switching process.

Still another aspect of the present invention achieves an effect of enabling higher quality scanning by means of image correction performing color correction for image data.

Still another aspect of the present invention achieves an effect of enabling higher quality scanning without a loss of image data along connecting points by means of image correction performing connecting point correction that corrects light detection leaks due to connecting points along the array of light detection elements in the line sensor.

Still another aspect of the present invention achieves an effect of enabling higher quality scanning by means of image correction performing dot correction for the image data.

Still another aspect of the present invention achieves an effect of enabling higher quality scanning by means of line-to-line correction performing dot correction for the image data subjected to the line-to-line correction.

Still another aspect of the present invention achieves an effect of enabling higher quality scanning as a result of performing the line-to-line correction for RGB image data after shading correction by means of illuminating the original image, converting to a digital signal the electrical signal converted from the optical image of the document image using illumination, performing shading correction for the converted digital signal, and performing the first switching process.

Still another aspect of the present invention achieves an effect of enabling lower power consumption and generated heat by illuminating by means of a light emitting diode (LED).

Still another aspect of the present invention achieves an effect of enabling effective use of space occupied by the contact-type color scanning units as a result of being able to provide a plurality of contact-type color scanning units within an image scanning device, regardless of the difference of the transporting direction, by means of a mechanism, wherein scanning of both the front side and back side of the transported document is performed by the contact-type color scanning units that perform a first switching process, wherein any two colors of the image data read by the RGB line sensor with different colors in the sub scanning direction reading the document that is automatically transported are switched with each other and the remaining one color is passed as is without switching, a line-to-line correction process, wherein the image data of the three RGB colors subjected to the first switching process are output as an RGB image data set, and a second switching process, wherein the image data subjected to the line-to-line correction process is received, the image data of the two colors subjected to the first switching process is switched again and output as the RGB data of a set based on the order of the sub scanning direction scanned by the RGB line sensor.

Still another aspect of the present invention achieves an effect of enabling efficient and high-quality document scanning by means of the contact-type color scanning units for front side scanning and for back side scanning, scanning both the front side and back side of a document one time in a single transport of the document.

Still another aspect of the present invention achieves an effect of having uniform image quality on the scanned front side and back side by means of the contact-type color scanning units each having the same performance.

Still another aspect of the present invention achieves an effect of enabling effective use of space occupied by the contact-type color scanning units as a result of being able to provide a plurality of contact-type color scanning units within an image scanning device, regardless of the difference of the transporting direction, by means of a structure wherein the contact-type color scanning units have the same RGB line sensor, overall shape, connector shape, and connector position, the order of each color in the sub scanning direction of the RGB line sensor that scans the transported document is disposed to be the reverse of the front and back of the document, one side of the transported document with a front side and a back side is scanned without switching with a first switching unit and a second switching unit, and the other side is switched with the first switching unit and the second switching unit and scanned. The present invention also achieves an effect of enabling the contact-type color scanning units to be mirror-surface positioned and an input/output amount terminal or the like to be provided on one side by means of switching the data of two RGB colors of the contact type scanning units.

Still another aspect of the present invention achieves an effect of enabling the output of RGB serial data as RGB image data for the same pixel, regardless of the difference of the transport direction of the document, by means of a first switching process wherein any two colors of the image data read by the RGB line sensor are switched with each other and the remaining one color is passed as is without switching, a line-to-line correction process wherein the image data of the three RGB colors subjected to the first switching process are output as an RGB image data set, and a second switching process wherein the image data subjected to the line-to-line correction process is received, the image data of the two colors subjected to the first switching process is switched again and output as the RGB data of a set based on the order of the sub scanning direction scanned by the RGB line sensor.

Still another aspect of the present invention achieves an effect of enabling the output of RGB serial data as RGB image data for the same pixel, regardless of the difference of the transport direction of the document, by means of the line-to-line correction outputting two pieces of the received image data subjected to the first switching process after holding for different time periods, as a set of RGB data.

Still another aspect of the present invention achieves an effect of enabling higher quality scanning by means of performing image correction for image data subjected to the second switching process.

Still another aspect of the present invention achieves an effect of enabling higher quality scanning by means of performing dot correction for image data.

Still another aspect of the present invention achieves an effect of enabling higher quality scanning by means of performing dot correction for image data subjected to the line-to-line correction.

Still another aspect of the present invention achieves an effect of enabling the implementation of any of the image scanning methods to a computer.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contact-type color scanning unit comprising:
a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction;
a first switching unit that performs first switching including switching between image data of any two colors and passing the remaining one color as is without switching thereby obtaining switched image data corresponding to each of red, green, and blue colors;
a correcting unit that performs line-to-line correction on the switched image data corresponding to each of red, green, and blue colors thereby producing corrected image data corresponding to each of red, green, and blue colors; and
a second switching unit that performs second switching including switching again the image data of the two colors that were switched in the first switching thereby producing switched-back image data corresponding to each of red, green, and blue colors that is in same order as an order alignment of the sensors in the sub scanning direction.

2. The contact-type color scanning unit according to claim 1, wherein the correcting unit includes a first storing unit and a second storing unit, the first storing unit configured to store therein a first piece of the switched image data and the second storing unit configured to store therein a second piece of the switched image data, the second piece being subsequent to the first piece in time series.

3. The contact-type color scanning unit according to claim 1, further comprising a plurality of illumination devices that illuminate the document from a plurality of directions.

4. The contact-type color scanning unit according to claim 1, further comprising an image correcting unit that performs image correction on the switched-back image data.

5. The contact-type color scanning unit according to claim 4, wherein the image correcting unit includes a color correcting unit that performs color correction on the switched-back image data.

6. The contact-type color scanning unit according to claim 4, wherein the image correcting unit includes a connecting-portion correcting unit that performs connecting-portion correction that includes correcting light detection leaks due to connecting-portion along an array of light detection elements in the line sensor.

7. The contact-type color scanning unit according to claim 4, wherein the image correcting unit includes a dot correcting unit that performs dot correction on the switched-back image data.

8. The contact-type color scanning unit according to claim 1, wherein the correcting unit includes a dot correcting unit that performs dot correction on the corrected image data.

9. The contact-type color scanning unit according to claim 3, further comprising:
an analog-digital converter that converts analog image data acquired by the line sensor to digital image data; and
a shading correcting unit that performs shading correction on the digital image data, wherein
the first switching unit performs the first switching on the digital image data subjected to the shading correction.

10. The contact-type color scanning unit according to claim 9, wherein the illumination device includes a light emitting diode (LED).

11. An image scanning unit comprising:
an automatic document transporting device that automatically transports a document from a first position to a second position; and
two contact-type color scanning units arranged between the first position and the second position, each of the contact-type color scanning units reading the document and outputting image data, each of the contact-type color scanning units including
a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction;
a first switching unit that performs first switching including switching between image data of any two colors and passing the remaining one color as is without switching thereby obtaining switched image data corresponding to each of red, green, and blue colors;
a correcting unit that performs line-to-line correction on the switched image data corresponding to each of red, green, and blue colors thereby producing corrected image data corresponding to each of red, green, and blue colors; and
a second switching unit that performs second switching including switching again the image data of the two colors that were switched in the first switching thereby producing switched-back image data corresponding to each of red, green, and blue colors that is in same order as an order alignment of the sensors in the sub scanning direction, wherein
one of the contact-type color scanning units is a front-side scanning unit that scans a front side and other of the contact-type color scanning units is a back-side scanning unit that scans a back side of the document.

12. The image scanning unit according to claim 11, wherein the front-side scanning unit and the back-side scanning unit scan both the front side and back side of the document respectively one time in a single transport of the document by the automatic document transporting device.

13. The image scanning unit according to claim 11, wherein the contact-type color scanning units have same performance.

14. The image scanning unit according to claim 11, wherein
the contact-type color scanning units have same RGB line sensor, overall shape, connector shape, and connector position,
the order of arrangement of sensors in the sub scanning direction is reverse for the front-side scanning unit and the back-side scanning unit,
one of the front side and the back side of the document is scanned without switching with the first switching unit and the second switching unit, and
other of the front side and the back side is switched with the first switching unit and the second switching unit and scanned.

15. A method of scanning an image to be implemented on a contact-type color scanning unit having a red-green-blue (RGB) line sensor including a plurality of sensors corresponding to each of red, green, and blue colors, sensors of different color being arranged along a sub scanning direction for reading a document and the sensors of same colors being arranged in a main scanning direction, the RGB line sensor acquiring image data corresponding to each of red, green, and blues color by scanning a document along the sub scanning direction and the main scanning direction, the method comprising:
first switching including switching between image data of any two colors and passing the remaining one color as is without switching thereby obtaining switched image data corresponding to each of red, green, and blue colors;
performing line-to-line correction on the switched image data corresponding to each of red, green, and blue colors thereby producing corrected image data corresponding to each of red, green, and blue colors; and
second switching including switching again the image data of the two colors that were switched in the first switching thereby producing switched-back image data corresponding to each of red, green, and blue colors that is in same order as an order alignment of the sensors in the sub scanning direction.

16. The method according to claim 15, wherein the performing includes storing a first piece of the switched image data into a first storing unit and storing a second piece of the switched image data into a second storing unit, the second piece being subsequent to the first piece in time series.

17. The method according to claim 15, further comprising performing image correction on the switched-back image data.

18. The method according to claim 17, wherein the performing image correction includes performing dot correction on the switched-back image data.

19. The method according to claim 15, wherein the performing includes performing dot correction on the corrected image data.

20. A computer program product stores therein a computer program that causes a computer to implement the method of scanning according to claim 15.
